(19) United States
(12) Patent Application Publication
(10) Pub. No.: US 2026/0326370 A1
(43) Pub. Date: Oct. 22, 2026

(54) EXTRUSION HEAD FOR THE ADDITIVE MANUFACTURE OF A MOULDED BODY

(71) Applicant: Plasmics GmbH, Wien (AT)

(72) Inventors: Frank Jakob, Feldkirch (AT); Stefan Spor, Wien (AT)

(21) Appl. No.: 19/115,695

(22) PCT Filed: Oct. 5, 2023
(86) PCT No.: PCT/AT2023/060347

§ 371 Date: Mar. 26, 2025

(30) Foreign Application Priority Data
Oct. 6, 2022 (AT) A 50778/2022

(51) Int. Cl. B29C 64/209; B29C 64/295; B33Y 30/00

(52) U.S. Cl. CPC B29C 64/209; B29C 64/295; B33Y 30/00

(57) ABSTRACT

An extrusion head for the additive production of a moulded body has a tubular body (5) of a ferromagnetic material. The tubular body (5) opens into an extrusion nozzle (4), is held on the feed side in a carrier (2) and forms an extrusion channel (3). At least one induction coil (6) encloses the tubular body (5) between the carrier (2) and the extrusion nozzle (4). The tubular body (5) has a guide flange (7) for the induced magnetic field, which guide flange (7) is arranged in the axial direction between the induction coil (6) and the carrier (2) and projects radially outwards.

### FIELD OF THE INVENTION

The invention relates to an extrusion head for the additive production of a moulded body with a tubular body made of a ferromagnetic material which tubular body opens into an extrusion nozzle, is held on the feed side in a carrier and forms an extrusion channel, and with at least one induction coil enclosing the tubular body between the carrier and the extrusion nozzle.

### DESCRIPTION OF THE PRIOR ART

It is known (EP 3 148 293 A1, WO 2016/102 669 A1) to provide an electrical induction heater instead of the usual electrical resistance heater in order to be able to advantageously provide the thermal energy required for melting a thermoplastic material fed in strand form to an extrusion head. For this purpose, a tubular body made of a ferromagnetic material forming an extrusion channel for melting the supplied thermoplastic material and opening into an extrusion nozzle for discharging the melt strand and at least one induction coil are provided, which induction coil encloses the tubular body at a radial distance. The inductively heated tubular body can thus transfer its heat to the thermoplastic material, which can be advantageously melted during its conveyance through the extrusion channel in a manner determined with regard to the temperature profile in order to be discharged as a melt strand from the extrusion nozzle closing the extrusion channel.

In order to provide an annular gap between the ferromagnetic tubular bodies and an electrically insulating sleeve enclosing these tubular bodies and surrounded by at least one induction coil, which annular gap makes heat transfer between the inductively heated tubular bodies and the insulating sleeve accommodating these tubular bodies more difficult, the ferromagnetic tubular bodies can have radially projecting spacer rings on the two end faces (WO 2016/102 669 A1).

The magnetic field induced in the tubular body forms a stray field in the area of the carrier holding the tubular body, which stray field impairs the heating power of the induction coil. If the carrier conventionally forms an aluminium or copper-based heat sink through which the thermoplastic material strand is fed to the tubular body, the additional problem arises that the stray magnetic field emerging from the inlet end of the tubular body, which is accommodated by the heat sink, induces eddy currents in the heat sink, which undesirably heat the heat sink. To improve the induction effect of the induction coil, it is known (EP 3 148 293 A1) to surround the induction coil on the outside with a soft iron cylinder, but this does not solve the problem of stray magnetic fields in the area of the supply-side end of the ferromagnetic tubular body held in a carrier.

### SUMMARY OF THE INVENTION

The invention is thus based on the task of equipping an extrusion head for the additive production of a moulded body with an inductive heating device in such a way that undesirable effects of stray magnetic fields in the feed-side area of the tubular bodies can be largely avoided.

Based on an extrusion head of the type described at the beginning, the invention solves the task set by the fact that the tubular body has a guide flange for the induced magnetic field which guide flange is arranged in the axial direction between the induction coil and the carrier and projects radially outwards.

The radially outwardly projecting guide flange results in a branching of the magnetic circuit with the effect that a considerable part of the magnetic field lines bundled in the guide flange emerge from the ferromagnetic tubular body, so that the residual magnetic field in the connection area of the tubular body to the carrier causes a comparatively low stray field, so that the inductive heating of the tubular body is improved. When the tubular body is, as usual, accommodated in a heat sink, this also means that the eddy currents induced in the metallic heat sink by the magnetic stray field can be reduced to a level that is insignificant for the temperature curve in the heat sink.

In order to minimise the residual field in the section of the tubular body adjoining the guide flange and extending towards the carrier, the section of the tubular body projecting axially beyond the guide flange towards the carrier can have a smaller wall thickness than the section of the tubular body enclosed by the induction coil.

If the tubular body between the induction coil and the extrusion nozzle is also provided with a radially outwardly projecting guide flange for the induced magnetic field, the associated bundling of the field lines can also be used to guide the magnetic circuit in the area of the extrusion nozzle in order to specify special induction conditions and thus ensure a predetermined temperature profile for the melt strand.

### BRIEF DESCRIPTION OF THE INVENTION

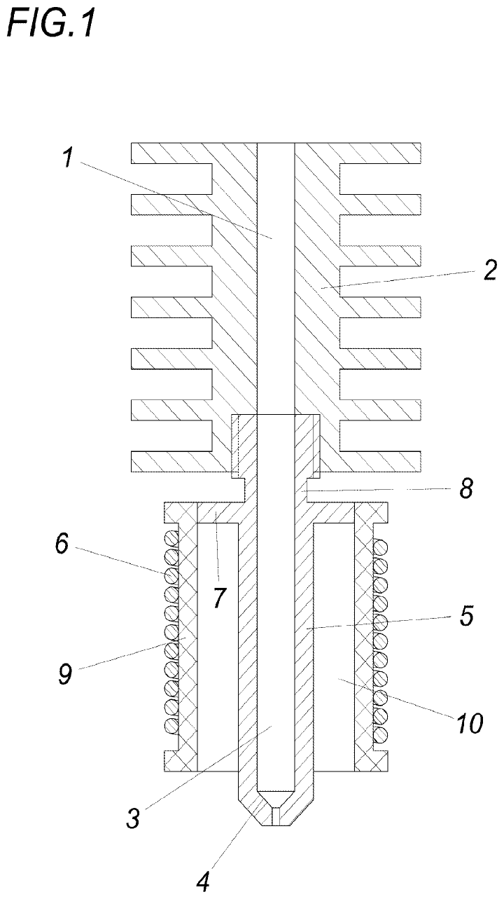

The subject of the invention is shown in the drawing, for example, wherein FIG. 1 shows

FIG. 1 a schematic longitudinal sectional view of an Extrusion head according to the invention in the area of the induction heater, and

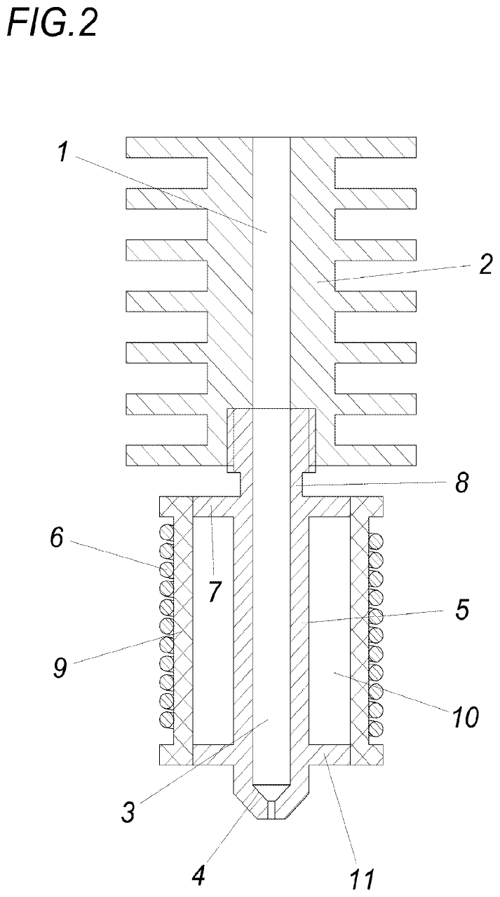

FIG. 2 a representation of an embodiment of an Extrusion head according to the invention corresponding to FIG. 1.

### DESCRIPTIONS OF THE PREFERRED EMBODIMENTS

In the drawing, only the section of the extrusion head used is shown schematically, which is intended for melting the thermoplastic material strand supplied thereto. This thermoplastic material strand, which is applied as a melt in layers for the additive manufacturing of a moulded body, is fed through a conveyor channel 1 of a carrier 2 to an extrusion channel 3 which continues the conveyor channel 1 and opens into an extrusion nozzle 4, in order to be melted along the extrusion channel 3 and discharged from the extrusion nozzle 4 as a melt strand.

For this purpose, an inductive heating device is provided which comprises a tubular body 5 made of a ferromagnetic material forming the extrusion channel 3 and at least one induction coil 6 enclosing the tubular body 5 at a radial distance. The carrier 2 receiving the tubular body 5 preferably forms an aluminium or copper-based heat sink into which the tubular body 5 is screwed, for example.

The tubular body 5 has a radially outwardly projecting guide flange 7 for the induced magnetic field in the axial direction between the induction coil 6 and the carrier 2, which diverts a considerable part of the magnetic field from the tubular body 5, so that the residual field in the area of the section 8 of the tubular body 5 between the guide flange 7 and the carrier 2 causes only a comparatively small stray field, which means that on the one hand the effect of the inductive heating can be improved and on the other hand the eddy currents induced in the carrier 2, which is designed as a metallic heat sink, are negligible.

In order to keep the residual magnetic field small, the section 8 of the tubular body 5 projecting from the guide flange 7 towards the carrier 2 can have a wall thickness that is smaller than the remaining thickness of the wall of the tubular body 5.

As can be seen from the drawing, the guide flange 7 of the tubular body 5 can advantageously serve as a support for the preferably ceramic coil carrier 9 in order to secure an annular gap 10 between the tubular body 5 and the coil carrier 9, which hinders heat transfer, without additional design measures. However, care must be taken to ensure that the position of the guide flange 7 relative to the induction coil 6 is selected in such a way that the magnetic partial circuit caused by the guide flange 7 is formed in a way that is favourable for the field lines.

In contrast to the embodiment according to FIG. 1, the tubular body 5 according to FIG. 2 has, in addition to the guide flange 7, which is effective in terms of magnetic shielding of the carrier 2, a further guide flange 11 in the axial direction between the induction coil 6 and the extrusion nozzle 4, which guide flange 11 also influences the course of the magnetic field lines and can therefore help to tune the magnetic circuit, in particular with regard to the requirements for the temperature profile of the melt strand in the area of the extrusion nozzle 4.

1. An extrusion head for the additive production of a moulded body said extrusion head comprising:
a tubular body of a ferromagnetic material, wherein the tubular body opens into an extrusion nozzle and is held on feed side in a carrier and forms an extrusion channel (3); and
at least one induction coil enclosing the tubular body between the carrier and the extrusion nozzle; and
wherein the tubular body has a radially outwardly projecting guide flange influencing an induced magnetic field, and said guide flange is arranged in an axial direction between the induction coil and the carrier.

2. The extrusion head according to claim 1, wherein a section of the tubular body projects axially beyond the guide flange towards the carrier has a wall thickness that is smaller than a wall thickness of a section of the tubular body that is enclosed by the induction coil.

3. The extrusion head according to claim 1, wherein the tubular body has a second radially outwardly projecting guide flange influencing the induced magnetic field between the induction coil and the extrusion nozzle.

4. The extrusion head according to claim 2, wherein the tubular body has a second radially outwardly projecting guide flange influencing the induced magnetic field between the induction coil and the extrusion nozzle.
